(19) United States
(12) Patent Application Publication
(10) Pub. No.: US 2005/0061956 A1
(43) Pub. Date: Mar. 24, 2005

(54) Unlocking method by identification of colored light rays and unlocking apparatus using this method

(76) Inventors: Jian-Choug Doong, Taipei (TW); Jin-In Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/668,334

(22) Filed: Sep. 24, 2003

(51) Int. Cl. G06M 7/00

(52) U.S. Cl. 250/221

(57) ABSTRACT

An unlocking method by identification of colored light rays and an unlocking apparatus using this method are disclosed. An emitting member and a receiving member are respectively mounted at two side of a keyhole of a lock. A key has a plurality of transparent colored plugs mounted on a shank thereof. When the shank is inserted in the keyhole, the emitting member gives off white light rays that then pass through the colored plugs and become colored light rays received into a receiver. If the color arrangement of the received light rays coincides with a stored arrangement, the key will be identified with the original key and the lock can be unlocked.

### BACKGROUND OF THE INVENTION

1. Field of the Invention

The present invention is related to an unlocking method, and more particularly to an unlocking method by identification of colored light rays and an unlocking apparatus using the method.

2. Description of Related Art

A conventional lock generally has a plurality of pins mounted in a lock core with various arrangements and is unlocked by a key with a plurality of teeth corresponding to the pins. However, the conventional lock has not enough security to prevent a thief from unlocking the lock by using a simple tool instead of a correct key.

For promoting the security, another lock using identification of light rays is invented. The lock has an emitting member to give off light rays and a receiving member to receive the rays respectively installed at two sides of a keyhole of a lock core. A correct key for the lock has a plurality of openings corresponding to positions of the lights. When the correct key is inserted in the keyhole, the light rays from the emitting member can pass through the openings and be received by the receiving member, so the lock can be unlocked.

However, this lock also has a low security and is easy to be unlocked in an unauthorized manner.

Therefore, the invention provides a lock to mitigate or obviate the aforementioned problems.

### SUMMARY OF THE INVENTION

The main objective of the present invention is to provide an unlocking method by identification of colored light rays which promotes the security of a lock.

Another objective of the present invention is to provide an unlocking apparatus using the unlocking method.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an unlocking apparatus in accordance with the invention;

FIG. 2 is a schematically sectional view of the unlocking apparatus in FIG. 1 when a key is inserted in a keyhole; and

FIG. 3 is a schematically sectional view of another embodiment of the unlocking apparatus in accordance with the invention.

### DETAILED DESCRIPTION OF THE PREFERRED EMBODIMENT

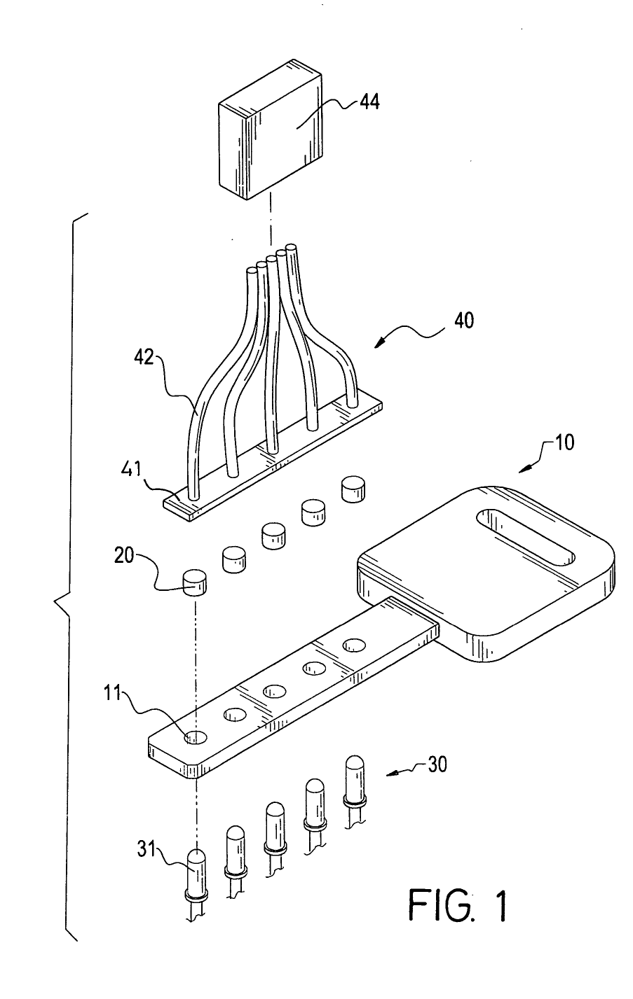

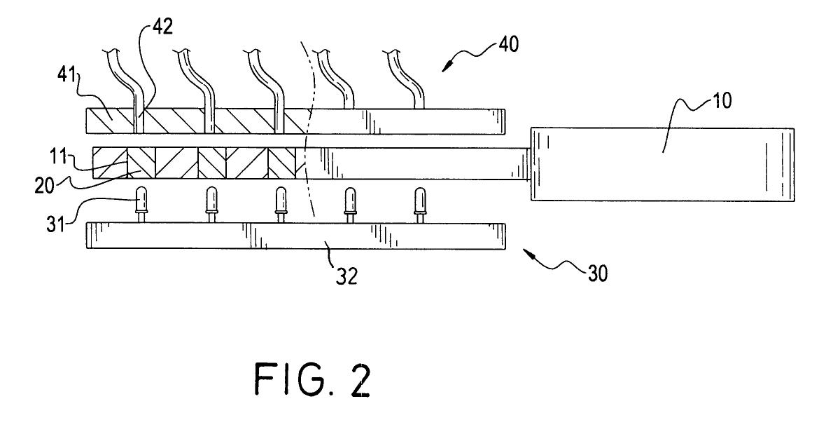

With reference to FIGS. 1 and 2, a lock (not shown) has a cylinder (not shown) installed in a doorframe, a lock core (not shown) rotatably received in the cylinder and a keyhole (not shown) longitudinally defined through the lock core.

An unlocking apparatus in accordance with the invention is composed of a key (10), an emitting member (30), and a receiving member (40). The emitting member (30) and the receiving member (40) are respectively mounted at two sides of the keyhole of the lock. The emitting member (30) has a plurality of illuminants (31) such as LEDs arranged along the keyhole and mounted on a first positioning strip (32). The receiving member (40) has a plurality of optical fibers (42) each with a first end in alignment with the corresponding illuminant (31) and a second end connected with a receiver (44) for identification of color. The first ends of the optical fibers (42) are mounted on a second positioning strip (41) facing the emitting member (30). The light rays given off from the illuminants (31) can be received by the corresponding optical fibers (42) and transferred into the receiver (44) for identification of color.

The optical fibers (42) also can be replaced with lenses (not shown) for receiving and transferring the light rays.

The key (10) has a shank (not numbered) for inserting in the keyhole, and a plurality of openings (11) is defined through the shank and respectively aligned with the illuminants (31) and the distal ends of the optical fibers (42). Each of the openings (11) has a transparent colored plug (20) mounted therein. The colored plugs (20) have various colors with a predetermined arrangement.

When the key (10) is inserted in the keyhole, white light rays from the illuminants (31) pass through the respective transparent colored plugs (20) and become light rays with various colors corresponding to the transparent colored plugs (20) and are received by the optical fibers (42) and the receiver (44).

When assembly of the lock, the correct color arrangement of the transparent plugs (20) is set and stored in the lock. If the light rays passing through the transparent plugs (20) have a color arrangement that coincides with the stored arrangement, the lock can be unlocked. Otherwise, the lock cannot be unlocked.

Therefore, an unlocking method according to the present invention has the following steps of:
1. Initially, an original key is inserted in the keyhole of the lock core;
2. White light rays are given off from the emitting member and which then pass through the transparent colored plugs;
3. The light rays passing through the transparent colored plugs are received by optical fibers and transferred into a receiver, and the color arrangement of the light rays is set and stored;
4. A key is inserted in the keyhole for unlocking, and white light rays are given off from the emitting member and which then pass through the transparent colored plugs;
5. The colored light rays are received by the optical fibers and transferred into the receiver;
6. The color arrangement of the key is compared with the stored arrangement to identify the key.

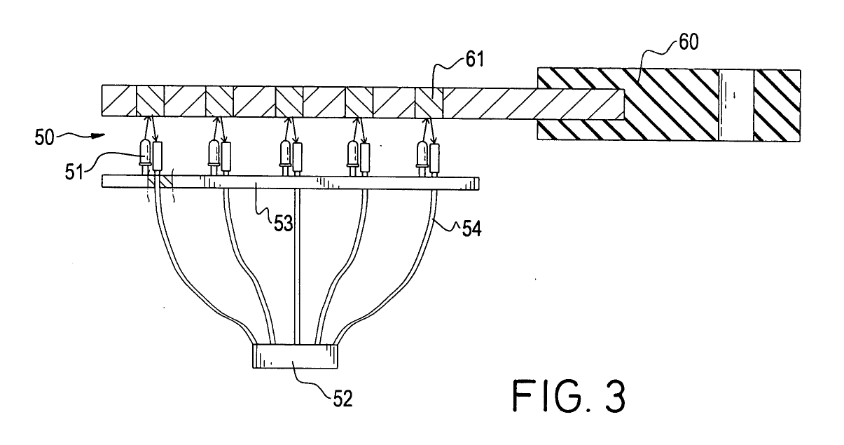

With reference to FIG. 3, in another embodiment of the invention, the unlocking apparatus has an emitting and receiving assembly (50) installed at a side of the keyhole. The emitting and receiving assembly (50) has an emitting member being composed of a plurality of illuminants (51) mounted on a positioning strip (53) at the side of the keyhole. A receiving member has a plurality of optical fibers (54) respectively mounted beside the illuminants (51) and connected with a receiver (52). A key (60) has a plurality of reflective colored plugs (61) mounted in a shank thereof and respectively aligned with the illuminants (51) and the optical fibers (54). The reflective colored plugs (61) have various colors with a predetermined arrangement.

When the key (60) is inserted in the keyhole, white light rays emitted from the illuminants (51) are reflected by the reflective colored plugs (61) and become colored light rays received by the optical fibers (54) for identification. In a situation of the color arrangement of the reflected light rays coinciding with the stored arrangement, the lock can be unlocked.

Moreover, the key of the present invention also can have a plurality of teeth formed on the shank as in a common key matching a mechanical lock for increasing its security.

Because the colored plugs (20, 61) of the key (10, 60) can have numerous arrangements, it is difficult for a thief to unlock a lock made in accordance with the present invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An unlocking apparatus for a lock having a keyhole, the unlocking apparatus comprising:
an emitting member adapted to be mounted at a side of the keyhole of the lock, the emitting member having a plurality of illuminants adapted to be arranged along the keyhole;
a receiving member adapted to be mounted at a side of the keyhole and facing the emitting member, the receiving member having a receiver for identification of color; and
a key having a shank for inserting in the keyhole, and a plurality of transparent colored plugs respectively mounted in the shank and aligned with the illuminants when the shank is inserted in the keyhole.

2. The unlocking apparatus as claimed in claim 1, wherein the receiving member further has a plurality of optical fibers each with a first end in alignment with one of the illuminants and a second end connected with the receiver.

3. The unlocking apparatus as claimed in claim 2, wherein the illuminants are mounted on a first positioning strips, and the first ends of the optical fibers are mounted on a second positioning strip facing the illuminants.

4. An unlocking apparatus for a lock having a keyhole, and the unlocking apparatus comprising:
a plurality of illuminants adapted to be mounted at a side of the keyhole of the lock;
a plurality of optical fibers respectively mounted beside the illuminants and connected with a receiver for identification of color; and
a key having a shank for inserting in the keyhole, and a plurality of reflective colored plugs respectively mounted in the shank and aligned with the illuminants and the optical fibers when the shank is inserted in the keyhole.

5. The unlocking apparatus as claimed in claim 4, wherein the illuminants and the optical fibers are mounted on a positioning strip.

6. An unlocking method by identification of colored light rays comprising the steps:
initially inserting an original key with transparent colored plugs in a keyhole of a lock;
white light rays being given off from an emitting member and passing through the transparent colored plugs;
receiving the light rays through the transparent colored plugs into a receiver, and storing the color arrangement of the light rays;
inserting a key in the keyhole for unlocking while white light rays are being given off from the emitting member and passing through transparent colored plugs of this key;
receiving the colored light rays into the receiver; and
comparing the color arrangement of the key with the stored arrangement to identify the key.

7. An unlocking method by identification of colored light rays comprising the steps:
initially inserting an original key with reflective colored plugs in a keyhole of a lock;
white light rays being given off from an emitting member and reflected by reflective colored plugs;
receiving the light rays from the reflective colored plugs by optical fibers and transferring into a receiver, and storing the color arrangement of the light rays;
inserting a key in the keyhole for unlocking while white light rays are being given off from the emitting member and reflected by reflective colored plugs of this key;
receiving the colored light rays by the optical fibers and transferring into the receiver; and
comparing the color arrangement of the key with the stored arrangement to identify the key.
